(19) United States
(12) Patent Application Publication
(10) Pub. No.: US 2026/0267735 A1
(43) Pub. Date: Sep. 10, 2026

(54) ADVANCED CORRECTABLE VOLATILE MEMORY ERROR TRACKING WITH CONFIGURABLE BLOCK GRANULARITY

(71) Applicant: Micron Technology, Inc., Boise, ID (US)

(72) Inventors: Parth Sangani, Santa Clara, CA (US); Ravi Kiran Gummaluri, Fremont, CA (US); Su Wei Lim, Penang (MY); Thomas Couch, Woodside, CA (US); Ankush Lal, Cupertino, CA (US)

(21) Appl. No.: 19/552,836

(22) Filed: Feb. 27, 2026

Related U.S. Application Data
(60) Provisional application No. 63/766,864, filed on Mar. 4, 2025.

(51) Int. Cl. G06F 11/10

(52) U.S. Cl. CPC G06F 11/1048; G06F 11/1004

(57) ABSTRACT

Methods, systems, and devices for Advanced Correctable Volatile Memory Error (ACVME) tracking with configurable block granularity are described. A host system may configure a memory system to utilize a block-based granularity and a size of each block via an indication. Based on the configured block size, the memory system may perform error tracking, in some cases based on determining a quantity of blocks for which to track errors, and may report one or more memory events when errors for associated blocks satisfy a threshold. By receiving reports on memory events for each tracked block, the host system may perform one or more corrective actions, including refraining from accessing erroneous blocks, correcting one or more errors, or copying block data and redirecting associated commands. In some examples, error tracking may be based on an indication of support for block-based granularity, and the report may indicate one or more addresses.

### CROSS REFERENCE

The present Application for Patent claims priority to U.S. Patent Application No. 63/766,864 by Sangani et al., entitled “ADVANCED CORRECTABLE VOLATILE MEMORY ERROR TRACKING WITH CONFIGURABLE BLOCK GRANULARITY,” filed Mar. 4, 2025, which is assigned to the assignee hereof, and which is expressly incorporated by reference in its entirety herein.

### TECHNICAL FIELD

The following relates to one or more systems for memory, including Advanced Correctable Volatile Memory Error (ACVME) tracking with configurable block granularity.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports Advanced Correctable Volatile Memory Error (ACVME) tracking with configurable block granularity in accordance with examples as disclosed herein.

FIG. 2 shows an example of a granularity diagram that supports ACVME tracking with configurable block granularity in accordance with examples as disclosed herein.

FIG. 3 shows an example of a process flow that supports ACVME tracking with configurable block granularity in accordance with examples as disclosed herein.

FIG. 4 shows a block diagram of a memory system that supports ACVME tracking with configurable block granularity in accordance with examples as disclosed herein.

FIG. 5 shows a block diagram of a host system that supports ACVME tracking with configurable block granularity in accordance with examples as disclosed herein.

FIGS. 6 and 7 show flowcharts illustrating a method or methods that support ACVME tracking with configurable block granularity in accordance with examples as disclosed herein.

### DETAILED DESCRIPTION

Memory devices may implement operations for error detection and correction, including Correctable Volatile Memory Error (CVME), or Advanced CVME (AVCME), operations. In some cases, ACVME operations may involve tracking errors according to different granularities. For example, a memory system may track errors across a full memory system (or full system), such as across a full host-device memory (HDM) range, as well as per device (or for a sub-memory system of a memory system or overall system), such as per memory media field replaceable unit (FRU) (e.g., per dual in-line memory module (DIMM)), as well as per rank. Error tracking may involve tracking errors for one or more units of a configured granularity (e.g., using a counter per granularity unit), and reporting a memory event for each unit of a selected granularity for which a threshold quantity of errors is satisfied. However, tracking errors across a full memory system or device, FRU, or rank may result in replacing one or more physical devices to mitigate error across such granularities. Physical device replacement may thus result in a system being offline for replacement, which may reduce performance and user experience, while also decreasing device lifetime as well as increasing material costs related to replacing components.

Techniques described herein may support a block-based granularity to provide one or more alternative solutions to physical device replacement. For example, a host system may configure a memory system to utilize a block-based granularity as well as a size of each block via an indication (e.g., via a set feature command). Based on the configured block size, the memory system may track errors detected in a quantity of blocks, and may report one or more memory events when errors for associated blocks satisfy (e.g., are greater than, are greater than or equal to) a threshold. By receiving reports on memory events for each tracked block, a host system may perform one or more corrective actions. For example, the host system may refrain from accessing erroneous blocks (e.g., blocks may be taken offline), correct errors, or copy block data and redirect associated commands. In some examples, error tracking may be based on the memory system indicating support for block-based granularity. The memory system may also indicate, in a report, an address for each block in the report, and may utilize a counter per tracked block. Further, the memory system may determine a quantity of blocks to track based on available resources, and may determine which blocks to track based on where errors are first detected and/or based on relative quantities of errors.

Using a block-based granularity may allow a host system to perform one or more actions to correct errors without replacing physical devices. For example, if one or more blocks exceeds a threshold error count, the host system may perform various actions described herein to correct errors or avoid using such blocks while keeping a memory system online, resulting in less downtime for systems and increasing device performance, while also extending device life and reducing material costs related to replacing devices. Further, using a block-based granularity may result in more efficient error tracking compared to alternative more complex tracking algorithms (e.g., algorithms tracking each error found in each page), while improving performance by correcting or mitigating errors.

In addition to applicability in memory systems as described herein, techniques for ACVME tracking with configurable block granularity may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling tracking of errors at a block-based granularity, which may decrease processing or latency times compared to pulling a memory system or system offline for physical device replacement, as well as improve response times or otherwise improve performance and user experience by correcting or mitigating errors in memory access and computation, among other benefits.

In addition to applicability in memory systems as described herein, techniques for ACVME tracking with configurable block granularity may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by implementing block-based granularity for error tracking, which may extend the life of electronic devices during operation and reduce the frequency that devices are replaced, thereby reducing electronic waste and a carbon footprint, among other benefits.

Features of the disclosure are illustrated and described in the context of systems and architectures. Features of the disclosure are further illustrated and described in the context of granularity diagrams, process flows, block diagrams, and flowcharts.

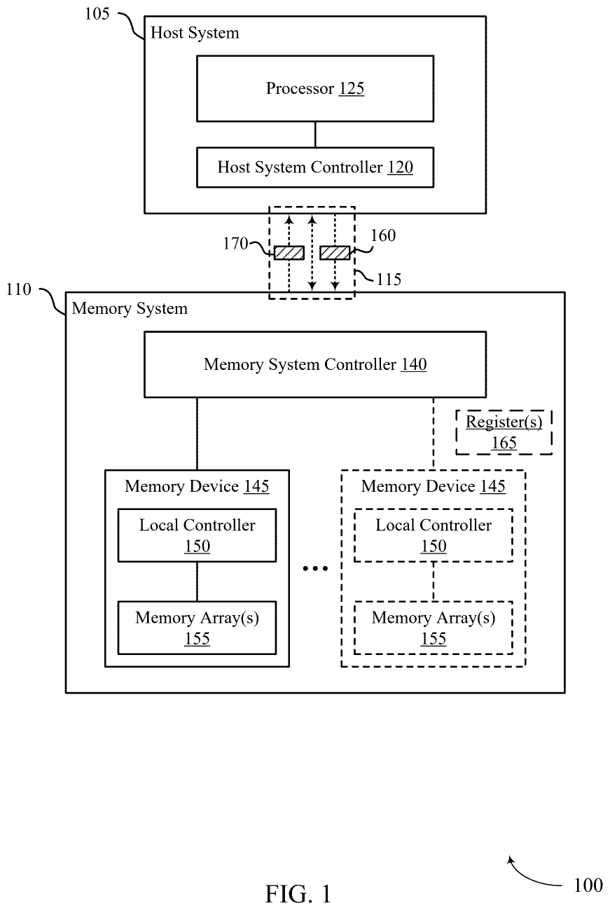

FIG. 1 shows an example of a system 100 that supports ACVME tracking with configurable block granularity in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, the memory system 110 may include different physical memory components. For example, the memory system 110 may include one or more memory media FRUs, such as DIMMs, which may be physical memory devices attached to one or more channels of the memory system 110. Each FRU may include one or more ranks, where a rank may represent a set of one or more memory devices (e.g., a set of multiple memory devices 145). Further, the memory system 110 may be an example of a compute-express link (CXL) device, and may implement one or more CXL protocols for communicating with the host system 105 and the FRUs, or for facilitating communication between the FRUs and the host system 105. The memory system 110 may in some cases implement CVME and/or ACVME operations. For example, the memory system 110 may track errors across the full memory system (e.g., full HDM range), per memory media FRU (e.g., per DIMM), or per rank for each FRU, and may transmit a report to the host system 105 after encountering a threshold quantity of errors for each tracked unit of a configured granularity. However, tracking errors across a full memory system or device, FRU, or rank may result in replacing one or more physical devices, resulting in reduced performance and user experience due to a system being offline for device replacement, while decreasing device lifetime and increasing material costs related to replacing components.

Techniques described herein may support a block-based granularity for error tracking. For example, the host system 105 may transmit an indication 160 (e.g., a set feature command) indicating to the memory system 110 to track errors using a block-based granularity and a size of each block. In some cases, the memory system 110 may include one or more registers 165 for storing configured values. For example, the memory system 110 may set one or more first bits to indicate to utilize the configured block-based granularity and one or more second bits to indicate the block size based on receiving the indication 160. The memory system 110 may also track errors detected in a quantity of blocks, and may transmit a report 170 indicating one or more blocks for which a respective quantity of errors satisfies a threshold. Reporting memory events for each tracked block may enable the host system 105 to perform one or more corrective actions without replacing physical devices, resulting in less downtime for the memory system 110 (and/or system 100) and increasing performance, while also extending device life and reducing material costs related to physical replacement of components. Additionally, or alternatively, while some examples herein may refer to a memory system 110 as a CXL device and to one or more memory devices 145 as an FRU of the CXL device, other examples may include a CXL device encompassing the system 100 with multiple connected memory systems 110 representing respective FRUs, among other combination of memory systems, host systems, systems, and memory devices.

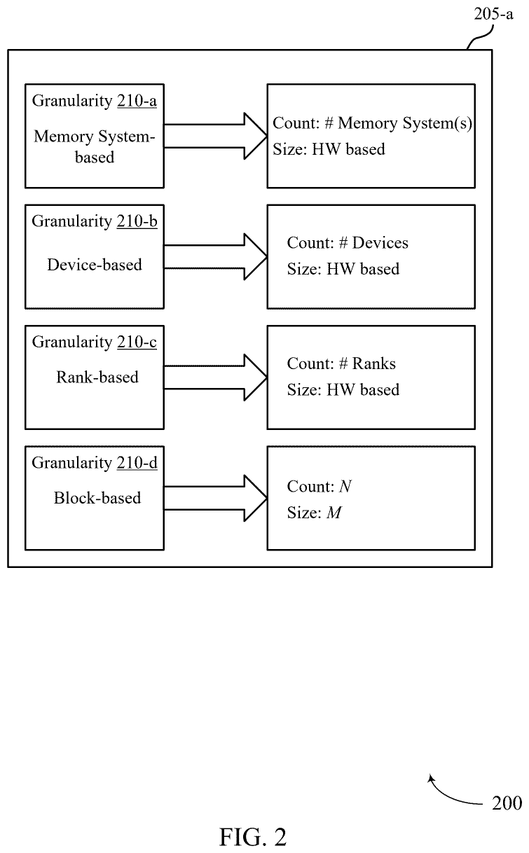

FIG. 2 shows an example of a granularity diagram 200 that supports ACVME tracking with configurable block granularity in accordance with examples as disclosed herein. One or more aspects of the granularity diagram 200 of FIG. 2 may implement or may be implemented by one or more aspects of the system 100. For example, the granularity diagram 200 may illustrate a configuration 205 for multiple potential granularities 210 supported at the memory system 110 for performing ACVME operations, including error tracking. In some cases, the configuration 205 may support a block-based granularity (e.g., a configurable block granularity) as described herein.

For example, the memory system 110 may in some cases support three granularities 210, including a granularity 210-a, a granularity 210-b, and a granularity 210-c. In some examples, the granularity 210-a may represent a memory system-based granularity, such as a full HDM range granularity corresponding to the memory system 110 itself (e.g., a CXL device including the memory system 110). In some cases, a count (e.g., quantity) of instances of the granularity 210-a for which errors are tracked may include a single memory system, such as a single CXL device, or one or more memory systems. A size of the instance may be based on related hardware features, including an overall memory or computational capacity.

In some examples, the granularity 210-b may correspond to a device-based granularity, such as a memory media FRU-based granularity (e.g., per FRU, per DIMM), where a count of instances of a device-based granularity may be based on a quantity of FRUs of the memory system 110, such as a quantity of DIMMs. In some cases, there may be one DIMM per channel of the memory system 110 (e.g., the granularity may be channel-based), or there may be multiple DIMMs per channel. Additionally, or alternatively, a size of each FRU may be based on related hardware features, such as a quantity of, and memory capacity of, one or more memory devices combined across ranks within each FRU. Additionally, or alternatively, the granularity 210-c may represent a rank-based granularity (e.g., per rank). A count of ranks for which to track errors may also be based on a total quantity of ranks across one or more FRUs, while a size of each rank may be based on related hardware, such as a total combined memory capacity of one or more memory devices of each rank. In some cases, the granularity 210-c, or a rank-based granularity, may be the relatively smallest size of granularity for error tracking for a memory system which includes all banks and bank groups together.

In some examples, the memory system 110 may track errors across a full memory system or device (e.g., per full HDM range), per memory device or FRU (e.g., per DIMM), or per rank. For example, the memory system 110 may track errors across a respective quantity, or count, of units of a selected granularity 210, and may report a memory event when a quantity of errors of one unit satisfies a threshold quantity (e.g., when a CVME threshold has expired). For example, firmware of the memory system 110 may detect correctable errors in ranges defined by the granularities 210 (e.g., using one or more counters). By reporting on each granularity unit, the memory system 110 may reduce error reporting and associated overhead. However, a memory system-based granularity, a device-based granularity, and/or a rank-based granularity may in some cases be relatively limited regarding tracking relatively smaller areas of media. Additionally, or alternatively, counting errors at a rank-based granularity (or greater granularity) may result in physical replacement of one or more devices (e.g., DIMMs, a CXL device) to correct associated errors when a memory event (e.g., memory media event) is detected, resulting in increased down time for the memory system 110, reduced performance and user experience, decreased device lifetime, as well as increasing material costs.

In some examples, the configuration 205-a may support tracking errors per host configurable block size, which may improve overall system reliability, availability, and serviceability (RAS) capability. For example, the configuration 205-a may include a granularity 210-d, which may be an example of a block-based granularity (e.g., a per-block granularity) for ACVME as described herein. In some examples, the granularity 210-d may have a configurable size. For example, the host system 105 may be operable to specify (e.g., configure) a size N for the block granularity, while the memory system 110 (e.g., a CXL device) may be operable to specify a corresponding count, or quantity of blocks tracked by ACVME operations. For example, the memory system 110 may include firmware with a flexibility to decide on how many blocks to track at a time (e.g., a first N blocks to receive errors). In some cases, using a block-based granularity may allow the memory system 110 to provide improved system level RAS, as well as increasing device performance, extending device life, reducing material costs, and simplifying tracking algorithms.

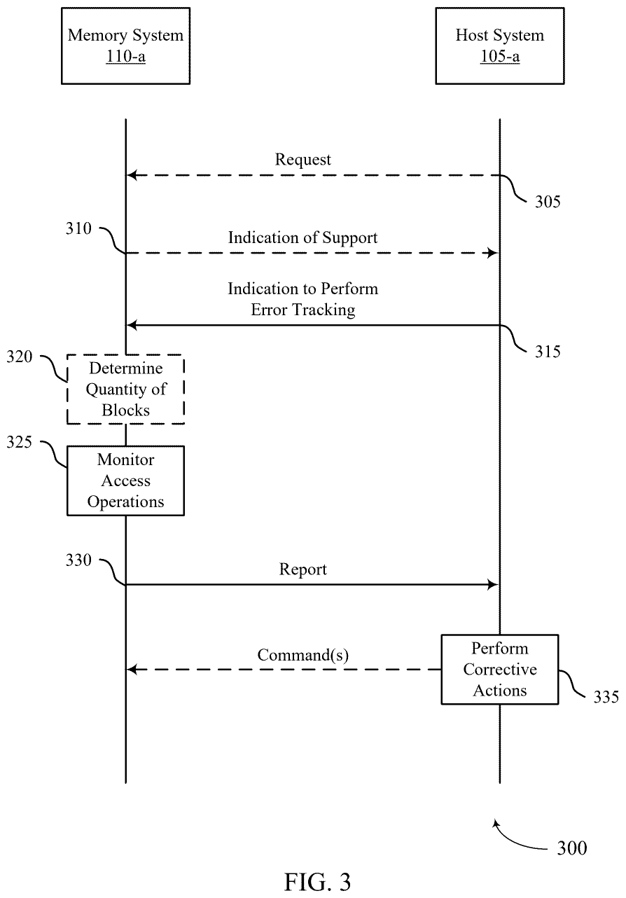

FIG. 3 shows an example of a process flow 300 that supports ACVME tracking with configurable block granularity in accordance with examples as disclosed herein. One or more aspects of the process flow 300 of FIG. 3 may implement or may be implemented by one or more aspects of the system 100 or the granularity diagram 200. For example, the process flow 300 may illustrate communication and operations performed at a host system 105-a and a memory system 110-a, which may be examples of the host system 105 and the memory system 110 described with respect to FIGS. 1 and 2. In some examples, the host system 105-a and the memory system 110-a may support communications and configurations for ACVME using a block-based granularity as described herein.

In some examples, the memory system 110-a may communicate one or more supported or configured parameters. For example, at 305, the host system 105-a may transmit a request to the memory system 110-a for one or more parameters, and in response, the memory system may transmit an indication of support for one or more granularities. The memory system 110-a may also be configured with a granularity and/or one or more related parameters or sizes. For example, at 315, the memory system 110-a may receive an indication to perform error tracking from the host system 105-a (e.g., based on sending the indication at 310). In some cases, the indication may indicate to perform error tracking using a block-based granularity and using a block size for the error tracking. In some examples, the indication at 315 may include the block size. Additionally, or alternatively, a granularity and one or more sizes may be indicated separately, or any granularity may be indicated.

The memory system 110-a may in some examples include one or more registers (e.g., register(s) 165) used for storing various parameters related to error tracking, where communications may be related to operations associated with accessing the one or more registers. For example, one or more first bits of the register may indicate a configured granularity (e.g., a configured CVME threshold granularity including a byte offset of 01 h and/or 00 h and a single byte). In some cases, a 00 h setting for a first field including the one or more first bits may indicate a full HDM range granularity, a 01 h setting may indicate a per media FRU granularity, a 02 h setting may indicate a per rank granularity, and a 03 h setting may indicate a per-block granularity. When a per-block granularity is used, one or more programmable thresholds may be at a per-block of device granularity.

Additionally, or alternatively, the register may include one or more second bits to indicate a block size, where an associated value may enable the host to configure a size of each block (e.g., a configured CVME per-block size including a byte offset of 19 h for a single byte). In some examples, a second field including the one or more second bits may be set if a block-based (e.g., per-block) granularity is set, such as via the first field. If a block-based granularity is not set, the second field may be ignored. In some cases, a unit size may include configurable values expressed as a power of 2 and ranging from 4096 bytes to 16 megabytes.

Further, one or more third bits of the register may indicate a supported granularity of multiple supported granularities (e.g., supported CVME threshold granularity flags including a byte offset of 00 h and a single byte). In some cases, the one or more third bits may be of a set of multiple third bits, including a bit[0] for indicating FRU based granularity support, a bit[1] for indicating rank-based granularity support, and a bit[2] to indicate block-based granularity support if set. For example, if bit[2] is set (e.g., bit[2] is set to a logical ‘1’), the memory system 110-a may implement, or support implementation of, block-based granularity error tracking as described herein.

In some examples, the memory system 110-a may read the register and report results in the indication sent at 310 in response to the request. For example, the indication at 310 may be a get command (e.g., a get feature command, a command component interface (CCI) get feature command) to see what granularities are supported by the memory system 110-a, and may return values of supported granularity (e.g., the one or more third bits), configured granularity (e.g., the one or more first bits), as well as block size (e.g., the one or more second bits) and other ACVME attributes related to the one or more registers. In some examples, the one or more third bits (e.g., bit[2]) may advertise the block-based granularity feature. Additionally, or alternatively, the memory system 110-a may receive a set command from the host system 105-a (e.g., a set feature command, a command component interface (CCI) set feature command) that may be associated with setting one or more bits of the one or more registers and including the indication to track errors. For example, in response to the set command, the memory system 110-a may set the one or more first bits of the register to indicate to perform the error tracking using the block-based granularity and may set the one or more second bits of the register to a value corresponding to an indicated block size. In some examples, the one or more first bits may allow the host to select the block-based granularity via a value (e.g., via the 03 h setting). Additionally, or alternatively, the host system 105-a may transmit the indication to use a block-based granularity after receiving the indication at 310 indicating a default or previously set granularity (e.g., full HDM range).

In some examples, at 320, the memory system 110-a may determine a quantity of N blocks based on one or more available resources at the memory system 110-a and based on a block size of M units indicated by the host system 105-a. For example, the quantity N may cover a subset of memory of a full CXL device, and may be based on available device overhead, available device processing power, available counters or processing associated with tracking and maintaining counters, among other resources. Additionally, or alternatively, the quantity N may be configured in firmware of the memory system 110-a.

At 325, the memory system 110-a may monitor access operations for one or more blocks for errors in response to the indication to perform error tracking using the block-based granularity and the block size. The monitoring may in some cases involve tracking respective quantities of errors for the determined quantity N of blocks. In some cases, the memory system 110-a may utilize one or more counters per tracked block to count a quantity of errors during a duration. For example, the memory system 110-a may include a dedicated (e.g., separate) CVME counter for N blocks of media on one or more memory devices.

In some examples, the memory system 110-a may select a list of N blocks to track based on a location in which errors are first detected during the monitoring. For example, the memory system 110-a may, based on monitoring for errors for each block of the memory system 110-a, detect errors in a first N blocks, and may select such blocks for tracking in the list of N blocks. The N blocks may also be selected based on respective quantities of errors detected. For example, the N blocks may be selected initially based on the N blocks including blocks with a relatively greatest quantity of errors relative to other blocks. Additionally, or alternatively, during operation, the memory system 110-a may determine that another block not being monitored has more errors than a first block within the N currently monitored blocks, for example, based on performing a periodic scan operation on all blocks. The memory system 110-a may update the N blocks to include the new block and to remove the first block. Additionally, or alternatively, the memory system 110-a may maintain one or more open slots (e.g., may track N+K blocks to report N blocks), where blocks may be added or removed from the N blocks based on the quantities of errors tracked for the N+K blocks.

At 330, the memory system 110-a may transmit a report indicating one or more blocks of the tracked or monitored quantity of blocks based on determining that a respective quantity of errors associated with each of the one or more blocks satisfies a threshold quantity of errors (e.g., a threshold of the CVME counter has been expired). For example, the memory system 110-a may include an entry for each of the blocks of the N blocks for which the respective quantity of errors satisfies the threshold. The report may indicate one or more addresses (e.g., device physical addresses (DPAs)) associated with the one or more blocks (e.g., the report may include informational severity). In some examples, the reporting may include the memory system 110-a generating a memory media event record when a respective CVME counter for a block satisfies a programmed threshold. In some cases, the report may indicate an associated rank, device (e.g., DIMM), or memory system (e.g., CXL device), which may be referred to as informational severity. For example, the host system 105-a may determine an associated rank, device, channel, or memory system based on one or more addresses indicated in the report.

At 335, the host system 105-a may perform one or more corrective actions associated with the one or more blocks based on the report. In some examples, the host system 105-a may pull one or more blocks and/or associated pages offline, for example, using the indicated addresses and known ranges based on the block size. The host system 105-a may refrain from accessing the one or more blocks, or from accessing one or more pages associated with the one or more blocks, for a duration. Additionally, or alternatively, the host system 105-a may correct one or more errors of one or more pages of the one or more blocks by transmitting one or more commands to retrieve data from one or more erroneous blocks, correcting the data, and transmitting one or more commands to write corrected information. Additionally, or alternatively, the host system 105-a may command the memory system 110-a to correct one or more errors, may transmit one or more commands to perform post-package repair to replace one or more problematic pages of one or more blocks containing errors, or may transmit one or more CXL commands. Further, the host system 105-a may support mirroring to avoid the erroneous blocks. For example, the host system 105-a may transmit one or more commands instructing the memory system 110-a to copy one or more pages of the one or more blocks to one or more second blocks, and the host system 105-a may redirect one or more access commands associated with the one or more blocks to the one or more second blocks.

In some examples, the memory system 110-a may continue to monitor blocks that have been mirrored or pulled offline. For example, the memory system 110-a may perform a patrol scrub within a duration (e.g., 24-hour period) on all blocks to track any erroneous blocks that show errors. Additionally, or alternatively, the memory system 110-a may reset one or more counters for one or more blocks after a duration. In another example, the memory system 110-a may refrain from monitoring one or more blocks once a threshold quantity of errors is met, and may monitor for new blocks with errors.

In some examples, the operations described herein may increase a performance the host system 105-a and the memory system 110-a. For example, by enabling memory (e.g., DRAM) event records to include per-block ACVME information, and making such information available to the host system 105-a via the report (e.g., via interrupt), efficiency and reliability of the memory system 110-a may be improved as the host system 105-a may take corrective action while maintaining one or more devices online (e.g., before one or more errors become uncorrectable). Further, the report may improve efficiency compared to more complex tracking algorithms. For example, the host system 105-a may receive a single event record per configurable block (e.g., per tracked block), as opposed to receiving a memory event record for each correctable error and tracking each DPA while performing a corresponding algorithm to decide on a corrective action.

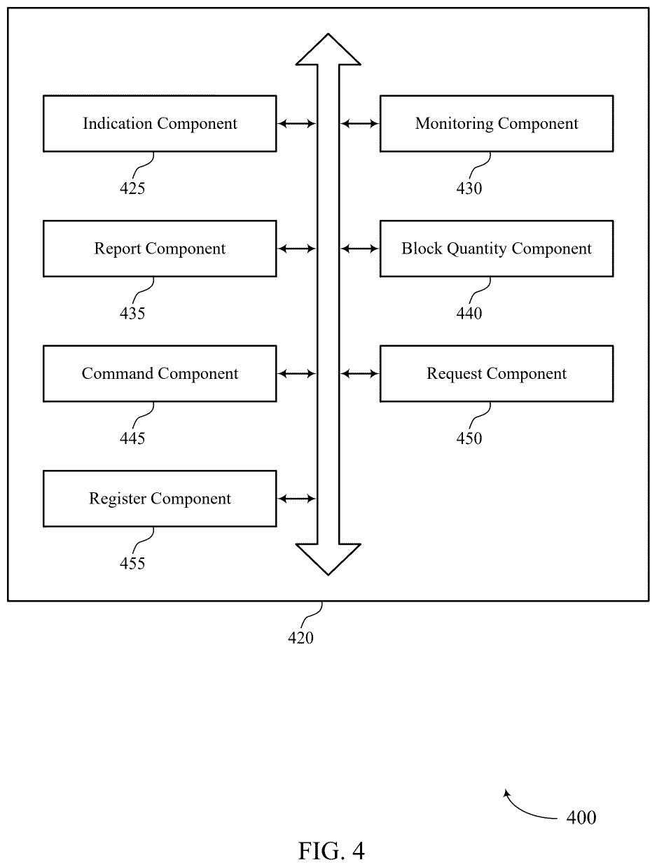

FIG. 4 shows a block diagram 400 of a memory system 420 that supports ACVME tracking with configurable block granularity in accordance with examples as disclosed herein. The memory system 420 may be an example of aspects of a memory system as described with reference to FIGS. 1 through 3. The memory system 420, or various components thereof, may be an example of means for performing various aspects of ACVME tracking with configurable block granularity as described herein. For example, the memory system 420 may include an indication component 425, a monitoring component 430, a report component 435, a block quantity component 440, a command component 445, a request component 450, a register component 455, or any combination thereof. Each of these components, or components of subcomponents thereof (e.g., one or more processors, one or more memories), may communicate, directly or indirectly, with one another (e.g., via one or more buses).

The indication component 425 may be configured as or otherwise support a means for receiving an indication to perform error tracking using a block-based granularity and a block size for the error tracking. The monitoring component 430 may be configured as or otherwise support a means for monitoring access operations for a plurality of blocks for errors in response to the indication to perform error tracking using the block-based granularity and the block size, where the monitoring includes tracking respective quantities of errors for a quantity of blocks of the plurality of blocks. The report component 435 may be configured as or otherwise support a means for transmitting a report indicating one or more blocks of the quantity of blocks based on determining that the respective quantities of errors associated with each of the one or more blocks satisfies a threshold quantity of errors.

In some examples, the indication component 425 may be configured as or otherwise support a means for transmitting, by the memory system, a second indication of support for the block-based granularity, where receiving the indication to perform the error tracking is based on transmitting the second indication.

In some examples, the request component 450 may be configured as or otherwise support a means for receiving a request from a host system for one or more parameters, where transmitting the second indication is in response to the request.

In some examples, the second indication includes one or more supported granularities including the block-based granularity, a configured granularity, one or more block sizes, or any combination thereof.

In some examples, the block quantity component 440 may be configured as or otherwise support a means for determining the quantity of blocks based on one or more available resources at the memory system, where tracking the respective quantities of errors for the quantity of blocks is based on determining the quantity of blocks.

In some examples, the command component 445 may be configured as or otherwise support a means for receiving one or more commands associated with one or more corrective actions based on transmitting the report.

In some examples, to support receiving the indication to perform error tracking, the command component 445 may be configured as or otherwise support a means for receiving, from a host system, a set command including the indication. In some examples, the register component 455 may be configured as or otherwise support a means for setting one or more first bits of a register to indicate to perform the error tracking using the block-based granularity and the register component 455 may be configured as or otherwise support a means for setting one or more second bits of the register to indicate the block size.

In some examples, the block-based granularity is of a plurality of granularities supported by the memory system. In some examples, the plurality of granularities includes the block-based granularity, a rank-based granularity, a channel-based granularity, a device-based granularity, a memory system-based granularity, or any combination thereof.

In some examples, a first block of the one or more blocks is associated with one or more first errors that are detected before one or more second errors during a duration, and the one or more second errors are associated with a second block of the plurality of blocks; or each block of the one or more blocks are associated with a greater quantity of errors than one or more additional blocks of the plurality of blocks.

In some examples, the report indicates one or more addresses associated with the one or more blocks.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

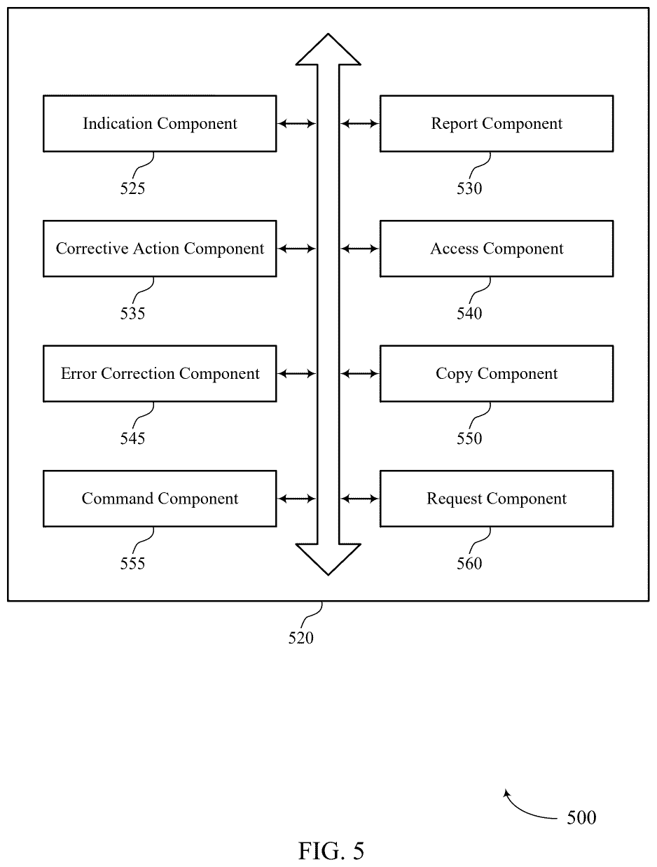

FIG. 5 shows a block diagram 500 of a host system 520 that supports ACVME tracking with configurable block granularity in accordance with examples as disclosed herein. The host system 520 may be an example of aspects of a host system as described with reference to FIGS. 1 through 3. The host system 520, or various components thereof, may be an example of means for performing various aspects of ACVME tracking with configurable block granularity as described herein. For example, the host system 520 may include an indication component 525, a report component 530, a corrective action component 535, an access component 540, an error correction component 545, a copy component 550, a command component 555, a request component 560, or any combination thereof. Each of these components, or components of subcomponents thereof (e.g., one or more processors, one or more memories), may communicate, directly or indirectly, with one another (e.g., via one or more buses).

The indication component 525 may be configured as or otherwise support a means for transmitting, to a memory system, an indication to perform error tracking using a block-based granularity and a block size for the error tracking. The report component 530 may be configured as or otherwise support a means for receiving, from the memory system, a report indicating one or more blocks, each block of the one or more blocks associated with a respective quantity of errors that satisfies a threshold quantity of errors. The corrective action component 535 may be configured as or otherwise support a means for performing one or more corrective actions associated with the one or more blocks based on the report.

In some examples, the indication component 525 may be configured as or otherwise support a means for receiving a second indication of support for the block-based granularity at a memory system, where transmitting the indication to perform the error tracking is based on the second indication.

In some examples, the request component 560 may be configured as or otherwise support a means for transmitting a request for one or more parameters, where receiving the second indication is in response to the request.

In some examples, the second indication includes one or more supported granularities including the block-based granularity, a configured granularity, one or more block sizes, or any combination thereof.

In some examples, to support performing one or more corrective actions, the access component 540 may be configured as or otherwise support a means for refraining from accessing the one or more blocks, or from accessing one or more pages associated with the one or more blocks, for a duration. In some examples, to support performing one or more corrective actions, the error correction component 545 may be configured as or otherwise support a means for correcting one or more errors of one or more pages of the one or more blocks. In some examples, to support performing one or more corrective actions, the copy component 550 may be configured as or otherwise support a means for copying one or more pages of the one or more blocks to one or more second blocks and redirecting one or more access commands associated with the one or more blocks to the one or more second blocks based on the copying.

In some examples, to support performing one or more corrective actions, the command component 555 may be configured as or otherwise support a means for transmitting one or more commands associated with the one or more corrective actions based on receiving the report.

In some examples, to support transmitting the indication to perform error tracking, the command component 555 may be configured as or otherwise support a means for transmitting a set command including the indication, the set command associated with setting one or more bits of a register.

In some examples, the block-based granularity is of a plurality of granularities supported by the memory system. In some examples, the plurality of granularities includes the block-based granularity, a rank-based granularity, a channel-based granularity, a device-based granularity, a memory system-based granularity, or any combination thereof.

In some examples, a first block of the one or more blocks is associated with one or more first errors that are detected before one or more second errors during a duration, and the one or more second errors associated with a second block of a plurality of blocks including the one or more blocks; or each block of the one or more blocks are associated with a greater quantity of errors than one or more additional blocks of the plurality of blocks.

In some examples, the report indicates one or more addresses associated with the one or more blocks.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

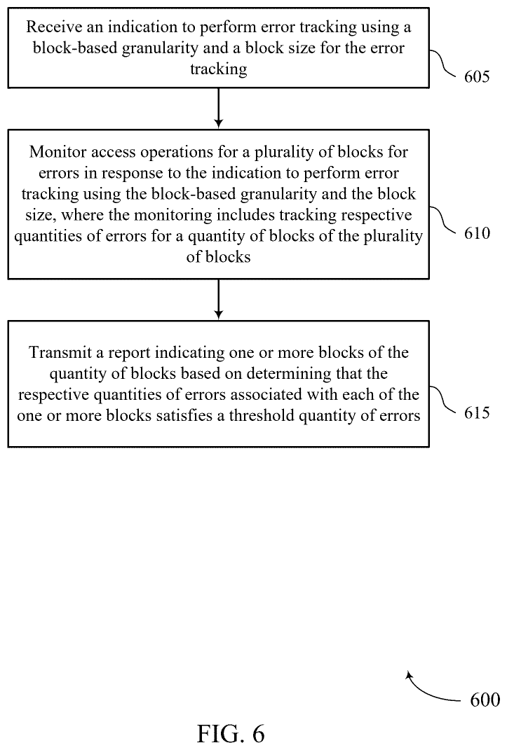

FIG. 6 shows a flowchart illustrating a method 600 that supports ACVME tracking with configurable block granularity in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving an indication to perform error tracking using a block-based granularity and a block size for the error tracking. In some examples, aspects of the operations of 605 may be performed by an indication component 425 as described with reference to FIG. 4. Further, the operations at 605 may be performed in accordance with examples as disclosed herein. For example, the memory system may receive an indication 160 to perform error tracking using the granularity 210-d (e.g., a block-based granularity) and indicating a size M—e.g., as described herein, including with reference to the operations described in FIG. 1 and at 315 of FIG. 3.

At 610, the method may include monitoring access operations for a plurality of blocks for errors in response to the indication to perform error tracking using the block-based granularity and the block size, where the monitoring includes tracking respective quantities of errors for a quantity of blocks of the plurality of blocks. In some examples, aspects of the operations of 610 may be performed by a monitoring component 430 as described with reference to FIG. 4. Further, the operations at 610 may be performed in accordance with examples as disclosed herein. For example, the memory system may monitor access operations for N blocks using one or more counters—e.g., as described herein, including with reference to the operations described at 325 of FIG. 3.

At 615, the method may include transmitting a report indicating one or more blocks of the quantity of blocks based on determining that the respective quantities of errors associated with each of the one or more blocks satisfies a threshold quantity of errors. In some examples, aspects of the operations of 615 may be performed by a report component 435 as described with reference to FIG. 4. Further, the operations at 615 may be performed in accordance with examples as disclosed herein. For example, the memory system may transmit a report for one or more blocks when one or more respective CVME counters satisfy a threshold—e.g., as described herein, including with reference to the operations described at 330 of FIG. 3.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication to perform error tracking using a block-based granularity and a block size for the error tracking; monitoring access operations for a plurality of blocks for errors in response to the indication to perform error tracking using the block-based granularity and the block size, where the monitoring includes tracking respective quantities of errors for a quantity of blocks of the plurality of blocks; and transmitting a report indicating one or more blocks of the quantity of blocks based on determining that the respective quantities of errors associated with each of the one or more blocks satisfies a threshold quantity of errors.

Aspect 2: The method, apparatus, or non-transitory computer-readable medium of aspect 1, further including operations, features, circuitry, logic, means, or instructions, or any combination thereof for transmitting, by the memory system, a second indication of support for the block-based granularity, where receiving the indication to perform the error tracking is based on transmitting the second indication.

Aspect 3: The method, apparatus, or non-transitory computer-readable medium of aspect 2, further including operations, features, circuitry, logic, means, or instructions, or any combination thereof for receiving a request from a host system for one or more parameters, where transmitting the second indication is in response to the request.

Aspect 4: The method, apparatus, or non-transitory computer-readable medium of any of aspects 2 through 3, where the second indication includes one or more supported granularities including the block-based granularity, a configured granularity, one or more block sizes, or any combination thereof.

Aspect 5: The method, apparatus, or non-transitory computer-readable medium of any of aspects 1 through 4, further including operations, features, circuitry, logic, means, or instructions, or any combination thereof for determining the quantity of blocks based on one or more available resources at the memory system, where tracking the respective quantities of errors for the quantity of blocks is based on determining the quantity of blocks.

Aspect 6: The method, apparatus, or non-transitory computer-readable medium of any of aspects 1 through 5, further including operations, features, circuitry, logic, means, or instructions, or any combination thereof for receiving one or more commands associated with one or more corrective actions based on transmitting the report.

Aspect 7: The method, apparatus, or non-transitory computer-readable medium of any of aspects 1 through 6, where receiving the indication to perform error tracking includes operations, features, circuitry, logic, means, or instructions, or any combination thereof for receiving, from a host system, a set command including the indication, the method further including: setting one or more first bits of a register to indicate to perform the error tracking using the block-based granularity and setting one or more second bits of the register to indicate the block size.

Aspect 8: The method, apparatus, or non-transitory computer-readable medium of any of aspects 1 through 7, where the block-based granularity is of a plurality of granularities supported by the memory system, where the plurality of granularities includes the block-based granularity, a rank-based granularity, a channel-based granularity, a device-based granularity, a memory system-based granularity, or any combination thereof.

Aspect 9: The method, apparatus, or non-transitory computer-readable medium of any of aspects 1 through 8, where a first block of the one or more blocks is associated with one or more first errors that are detected before one or more second errors during a duration, and the one or more second errors are associated with a second block of the plurality of blocks; or each block of the one or more blocks are associated with a greater quantity of errors than one or more additional blocks of the plurality of blocks.

Aspect 10: The method, apparatus, or non-transitory computer-readable medium of any of aspects 1 through 9, where the report indicates one or more addresses associated with the one or more blocks.

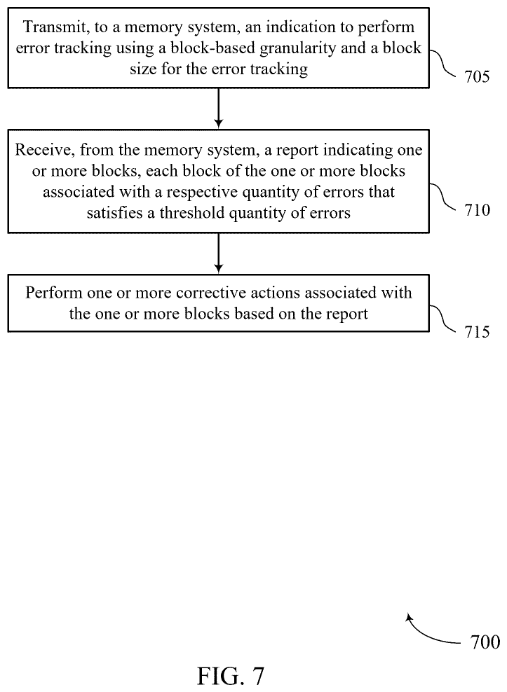

FIG. 7 shows a flowchart illustrating a method 700 that supports ACVME tracking with configurable block granularity in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include transmitting, to a memory system, an indication to perform error tracking using a block-based granularity and a block size for the error tracking. In some examples, aspects of the operations of 705 may be performed by an indication component 525 as described with reference to FIG. 5. Further, the operations at 705 may be performed in accordance with examples as disclosed herein. For example, the host system may transmit an indication 160 to perform error tracking using the granularity 210-d (e.g., a block-based granularity) and indicating a size M—e.g., as described herein, including with reference to the operations described in FIG. 1 and at 315 of FIG. 3.

At 710, the method may include receiving, from the memory system, a report indicating one or more blocks, each block of the one or more blocks associated with a respective quantity of errors that satisfies a threshold quantity of errors. In some examples, aspects of the operations of 710 may be performed by a report component 530 as described with reference to FIG. 5. Further, the operations at 710 may be performed in accordance with examples as disclosed herein. For example, the host system may receive a report for one or more blocks when one or more respective CVME counters satisfy a threshold—e.g., as described herein, including with reference to the operations described at 330 of FIG. 3.

At 715, the method may include performing one or more corrective actions associated with the one or more blocks based on the report. In some examples, aspects of the operations of 715 may be performed by a corrective action component 535 as described with reference to FIG. 5. Further, the operations at 715 may be performed in accordance with examples as disclosed herein. For example, the host system may perform various corrective actions, such as refraining from accessing blocks, correcting one or more errors, or mirroring blocks—e.g., as described herein, including with reference to the operations described at 335 of FIG. 3.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for transmitting, to a memory system, an indication to perform error tracking using a block-based granularity and a block size for the error tracking; receiving, from the memory system, a report indicating one or more blocks, each block of the one or more blocks associated with a respective quantity of errors that satisfies a threshold quantity of errors; and performing one or more corrective actions associated with the one or more blocks based on the report.

Aspect 12: The method, apparatus, or non-transitory computer-readable medium of aspect 11, further including operations, features, circuitry, logic, means, or instructions, or any combination thereof for receiving a second indication of support for the block-based granularity at a memory system, where transmitting the indication to perform the error tracking is based on the second indication.

Aspect 13: The method, apparatus, or non-transitory computer-readable medium of aspect 12, further including operations, features, circuitry, logic, means, or instructions, or any combination thereof for transmitting a request for one or more parameters, where receiving the second indication is in response to the request.

Aspect 14: The method, apparatus, or non-transitory computer-readable medium of any of aspects 12 through 13, where the second indication includes one or more supported granularities including the block-based granularity, a configured granularity, one or more block sizes, or any combination thereof.

Aspect 15: The method, apparatus, or non-transitory computer-readable medium of any of aspects 11 through 14, where performing one or more corrective actions includes operations, features, circuitry, logic, means, or instructions, or any combination thereof for refraining from accessing the one or more blocks, or from accessing one or more pages associated with the one or more blocks, for a duration; correcting one or more errors of one or more pages of the one or more blocks; copying one or more pages of the one or more blocks to one or more second blocks and redirecting one or more access commands associated with the one or more blocks to the one or more second blocks based on the copying; or any combination thereof.

Aspect 16: The method, apparatus, or non-transitory computer-readable medium of any of aspects 11 through 15, where performing one or more corrective actions includes operations, features, circuitry, logic, means, or instructions, or any combination thereof for transmitting one or more commands associated with the one or more corrective actions based on receiving the report.

Aspect 17: The method, apparatus, or non-transitory computer-readable medium of any of aspects 11 through 16, where transmitting the indication to perform error tracking includes operations, features, circuitry, logic, means, or instructions, or any combination thereof for transmitting a set command including the indication, the set command associated with setting one or more bits of a register.

Aspect 18: The method, apparatus, or non-transitory computer-readable medium of any of aspects 11 through 17, where the block-based granularity is of a plurality of granularities supported by the memory system, where the plurality of granularities includes the block-based granularity, a rank-based granularity, a channel-based granularity, a device-based granularity, a memory system-based granularity, or any combination thereof.

Aspect 19: The method, apparatus, or non-transitory computer-readable medium of any of aspects 11 through 18, where a first block of the one or more blocks is associated with one or more first errors that are detected before one or more second errors during a duration, and the one or more second errors associated with a second block of a plurality of blocks including the one or more blocks; or each block of the one or more blocks are associated with a greater quantity of errors than one or more additional blocks of the plurality of blocks.

Aspect 20: The method, apparatus, or non-transitory computer-readable medium of any of aspects 11 through 19, where the report indicates one or more addresses associated with the one or more blocks.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication to perform error tracking using a block-based granularity and a block size for the error tracking;
monitor access operations for a plurality of blocks for errors in response to the indication to perform error tracking using the block-based granularity and the block size, wherein the monitoring comprises tracking respective quantities of errors for a quantity of blocks of the plurality of blocks; and
transmit a memory media event record indicating one or more blocks of the quantity of blocks based on determining that the respective quantities of errors associated with each of the one or more blocks satisfies a threshold quantity of errors.

2. The memory system of claim 1, wherein the processing circuitry is further configured to cause the memory system to:
transmit, by the memory system, a second indication of support for the block-based granularity, wherein receiving the indication to perform the error tracking is based on transmitting the second indication.

3. The memory system of claim 2, wherein the processing circuitry is further configured to cause the memory system to:
receive a request from a host system for one or more parameters, wherein transmitting the second indication is in response to the request.

4. The memory system of claim 2, wherein the second indication comprises one or more supported granularities comprising the block-based granularity, a configured granularity, one or more block sizes, or any combination thereof.

5. The memory system of claim 1, wherein the processing circuitry is further configured to cause the memory system to:
determine the quantity of blocks based on one or more available resources at the memory system, wherein tracking the respective quantities of errors for the quantity of blocks is based on determining the quantity of blocks.

6. The memory system of claim 1, wherein the processing circuitry is further configured to cause the memory system to:
receive one or more commands associated with one or more corrective actions based on transmitting the memory media event record.

7. The memory system of claim 1, wherein receiving the indication to perform error tracking comprises the processing circuitry configured to cause the memory system to:
receive, from a host system, a set command comprising the indication, wherein the processing circuitry is further configured to cause the memory system to:
set one or more first bits of a register to indicate to perform the error tracking using the block-based granularity; and
set one or more second bits of the register to indicate the block size.

8. The memory system of claim 1, wherein the block-based granularity is of a plurality of granularities supported by the memory system, wherein the plurality of granularities comprises the block-based granularity, a rank-based granularity, a channel-based granularity, a device-based granularity, a memory system-based granularity, or any combination thereof.

9. The memory system of claim 1, wherein a first block of the one or more blocks is associated with one or more first errors that are detected before one or more second errors during a duration, and the one or more second errors are associated with a second block of the plurality of blocks; or each block of the one or more blocks are associated with a greater quantity of errors than one or more additional blocks of the plurality of blocks.

10. The memory system of claim 1, wherein the memory media event record indicates one or more addresses associated with the one or more blocks.

11. An apparatus, comprising:
processing circuitry associated with one or more memory devices and configured to cause the apparatus to:
transmit, to a memory system, an indication to perform error tracking using a block-based granularity and a block size for the error tracking;
receive, from the memory system, a memory media event record indicating one or more blocks, each block of the one or more blocks associated with a respective quantity of errors that satisfies a threshold quantity of errors; and
perform one or more corrective actions associated with the one or more blocks based on the memory media event record.

12. The apparatus of claim 11, wherein the processing circuitry is further configured to cause the apparatus to:
receive a second indication of support for the block-based granularity at a memory system, wherein transmitting the indication to perform the error tracking is based on the second indication.

13. The apparatus of claim 12, wherein the processing circuitry is further configured to cause the apparatus to:
transmit a request for one or more parameters, wherein receiving the second indication is in response to the request.

14. The apparatus of claim 12, wherein the second indication comprises one or more supported granularities comprising the block-based granularity, a configured granularity, one or more block sizes, or any combination thereof.

15. The apparatus of claim 11, wherein performing the one or more corrective actions comprises the processing circuitry configured to cause the apparatus to:
refrain from accessing the one or more blocks, or from accessing one or more first pages associated with the one or more blocks, for a duration;
correct one or more errors of one or more second pages of the one or more blocks;
copy the one or more second pages of the one or more blocks to one or more second blocks and redirect one or more access commands associated with the one or more blocks to the one or more second blocks based on the copying; or
any combination thereof.

16. The apparatus of claim 11, wherein performing the one or more corrective actions comprises the processing circuitry configured to cause the apparatus to:
transmit one or more commands associated with the one or more corrective actions based on receiving the memory media event record.

17. The apparatus of claim 11, wherein transmitting the indication to perform the error tracking comprises the processing circuitry configured to cause the apparatus to:
transmit a set command comprising the indication, the set command associated with setting one or more bits of a register.

18. The apparatus of claim 11, wherein the block-based granularity is of a plurality of granularities supported by the memory system, wherein the plurality of granularities comprises the block-based granularity, a rank-based granularity, a channel-based granularity, a device-based granularity, a memory system-based granularity, or any combination thereof.

19. The apparatus of claim 11, wherein a first block of the one or more blocks is associated with one or more first errors that are detected before one or more second errors during a duration, and the one or more second errors associated with a second block of a plurality of blocks comprising the one or more blocks; or each block of the one or more blocks are associated with a greater quantity of errors than one or more additional blocks of the plurality of blocks.

20. The apparatus of claim 11, wherein the memory media event record indicates one or more addresses associated with the one or more blocks.

21. A method by a memory system, comprising:
receiving an indication to perform error tracking using a block-based granularity and a block size for the error tracking;
monitoring access operations for a plurality of blocks for errors in response to the indication to perform the error tracking using the block-based granularity and the block size, wherein the monitoring comprises tracking respective quantities of errors for a quantity of blocks of the plurality of blocks; and
transmitting a memory media event record indicating one or more blocks of the quantity of blocks based on determining that a respective quantity of errors associated with each of the one or more blocks satisfies a threshold quantity of errors.

22. The method of claim 21, further comprising:
transmitting, by the memory system, a second indication of support for the block-based granularity, wherein receiving the indication to perform the error tracking is based on transmitting the second indication, and wherein the second indication comprises one or more supported granularities comprising the block-based granularity, a configured granularity, one or more block sizes, or any combination thereof.

23. The method of claim 22, further comprising:
receiving a request from a host system for one or more parameters, wherein transmitting the second indication is in response to the request.

24. The method of claim 21, further comprising:
determining the quantity of blocks based on one or more available resources at the memory system, wherein tracking the respective quantities of errors for the quantity of blocks is based on determining the quantity of blocks.

25. The method of claim 21, further comprising:
receiving one or more commands associated with one or more corrective actions based on transmitting the memory media event record.

26. The method of claim 21, wherein receiving the indication to perform the error tracking comprises:
receiving, from a host system, a set command comprising the indication, the method further comprising:
setting one or more first bits of a register to indicate to perform the error tracking using the block-based granularity; and
setting one or more second bits of the register to indicate the block size.

27. A method, comprising:
transmitting, to a memory system, an indication to perform error tracking using a block-based granularity and a block size for the error tracking;
receiving, from the memory system, a memory media event record indicating one or more blocks, each block of the one or more blocks associated with a respective quantity of errors that satisfies a threshold quantity of errors; and
performing one or more corrective actions associated with the one or more blocks based on the memory media event record.

28. The method of claim 27, further comprising:
transmitting a request for one or more parameters; and
receiving, in response to the request, a second indication of support for the block-based granularity at the memory system, wherein transmitting the indication to perform the error tracking is based on the second indication, and wherein the second indication comprises one or more supported granularities comprising the block-based granularity, a configured granularity, one or more block sizes, or any combination thereof.

29. The method of claim 27, wherein performing the one or more corrective actions comprises:
refraining from accessing the one or more blocks, or from accessing one or more first pages associated with the one or more blocks, for a duration;
correcting one or more errors of one or more second pages of the one or more blocks;
copying the one or more second pages of the one or more blocks to one or more second blocks and redirecting one or more access commands associated with the one or more blocks to the one or more second blocks based on the copying; or
any combination thereof.

30. A non-transitory computer-readable medium storing code, the code comprising instructions executable by one or more processors to:
receive an indication to perform error tracking using a block-based granularity and a block size for the error tracking;
monitor access operations for a plurality of blocks for errors in response to the indication to perform error tracking using the block-based granularity and the block size, wherein the monitoring comprises tracking respective quantities of errors for a quantity of blocks of the plurality of blocks; and
transmit a memory media event record indicating one or more blocks of the quantity of blocks based on determining that the respective quantities of errors associated with each of the one or more blocks satisfies a threshold quantity of errors.
